(19) United States
(12) Patent Application Publication
(10) Pub. No.: US 2018/0204477 A1
(43) Pub. Date: Jul. 19, 2018

(54) METHOD AND SYSTEM FOR TEMPLATED CONTENT GENERATION AND ASSESSMENT

(71) Applicant: VARAFY CORPORATION, Edmonton (CA)

(72) Inventors: Kenneth Richard FYFE, Edmonton (CA); Justin Daniel SHARP, Edmonton (CA)

(21) Appl. No.: 15/746,438

(22) PCT Filed: Jul. 20, 2016
(86) PCT No.: PCT/CA2016/050852

§ 371 Date: Jan. 22, 2018

Related U.S. Application Data
(60) Provisional application No. 62/195,188, filed on Jul. 21, 2015.

(51) Int. Cl. G09B 7/02; G06F 17/24; G06F 17/21

(52) U.S. Cl. CPC G09B 7/02; G06F 17/215; G06F 17/248

(57) ABSTRACT

A method and system is provided for generating a templatable item, which can include a text editor configured to generate numbers or text, a variable editor configured to generate a variable for the templatable item, an equation editor configured for generating an equation, and an image editor configured to generate an image, wherein the variable can include one or more of numbers, text, equations and images.

### CROSS-REFERENCE TO RELATED APPLICATIONS

This application claims priority of U.S. provisional patent application Ser. No. 62/195,188 filed Jul. 21, 2015, which is incorporated by reference into this application in its entirety.

### TECHNICAL FIELD

The present disclosure is related to the field of methods and systems for generating course content and for assessing a student's comprehension of the course content.

### BACKGROUND

In teaching and learning environments, there is a need to assess the students to determine their level of comprehension. Assessment provides valuable feedback to both the instructor and the students. However, once a particular problem has been used, there is now a danger that it can be passed on to subsequent students enrolled in the same or similar courses. This problem is known as academic integrity, and these issues have plagued educational institutions since their creation. This problem has been exacerbated in recent years with the broad range of social networks on the internet making it easy to collaborate. In addition to this, there are now sophisticated search tools and databases which make it relatively easy to find and obtain copyrighted material illegally.

One way to deal with the problem of academic integrity is to have the instructors continually generating new problems and solution sets for their classes. This, however, is very time consuming and tedious work. It is known to compose a problem statement and corresponding solution set known as an “item”, however, such item sets are static, that is, they are based on fixed, unchangeable sub-components.

It is, therefore, desirable to provide a method and system for generating course content and assessing a student's comprehension of the course content that overcomes the shortcomings of the prior art.

### SUMMARY

In some embodiments, a method and system can be provided for generating fully randomizable problems and solutions comprising variables that can be dynamic or changeable. Such problem sets and corresponding solutions are known as “templated items” or “templatable items” as they are referred to in the educational space. In some embodiments, the method and system can comprise several unique features: (i) differing levels of difficulty can be generated within the same problem, (ii) the drawings can be fully scaled to the randomized parameters, and (iii) detailed solutions, that can entail several pages of diagrams and algebra, can be automatically generated for each problem. With this method and system, a new set of assignment problems can be instantly generated for each class, or unique problems can be generated for each student in a class, if desired.

There are many benefits to this proposed method and system. Firstly, because it can instantly generate new random problem sets, an instructor will have no hesitations in posting the solutions, because there is no danger that a particular problem set will come up again in following years. Secondly, it can encourage student collaboration on assignments because the students are only going to be able to help each other by explaining the solution methodology, which aids both students, rather than directly copying solutions from one another. Thirdly, a web tool or mobile application tool can be provided whereby students can work on a problematic section of the course by working out an unlimited number of problems, with full solutions, until they grasp the concept. This approach can be further enhanced by the ability of the students being able to set the difficulty level for the problems, so that one may proceed by starting with easy problems, and then increasing the difficulty level as their confidence builds or to allow the method and system to control the difficulty similar to algorithms used for computer adaptive testing (“CAT”). Finally, the method and system can be a great boon for delivering problems with full solutions for the growing suite of online courses.

The above mentioned method and system for assignment or content generation creates a new problem: how to mark assignments that are unique to each student? Multiple choice assessment methods are commonly used, but are insufficient for many types of math, science and engineering problems, where many detailed steps are required to arrive at the answer, and those properly executed steps are nearly as important as the final answer, especially while the subject is being mastered. In some embodiments, the method and system can circumvent this issue.

### Areas of Application

The method and system presented herein can be useful for anyone who is interested in producing fixed or variable content. In the context of this description, we are primarily referring to educational content; e.g. daycare, K-12, post-secondary, technical tickets and certificates, and testing organizations. However, this methodology can equally be well applied to any application where variable text, equations and/or figures are required. In this sense, one area of application is for those who require one or many scaled, high quality images generated on the spot. Another application is for iterating through a wide variety of graphics to find one that is desired; point a case—a logo design.

Another area of application can be found in gaming where there is a need to generate random images on the fly such as objects and terrain. The functionality described herein can give the game developer nearly limitless possibilities when creating any type of object used within a game. Because the objects can all be variable based, real-time morphing and scaling can be built-in.

### Deployment

In some embodiments, the methods and systems described herein can be deployed in a cross-browser web application on PC's, tablets and smartphones. In addition to this, the methods and systems can be built as a native application to take advantage of characteristics of each platform. These platforms can include, but are not limited to, Mac OS X®, Windows®, Linux®, iOS®, Android® and Blackberry®, in addition to various gaming consoles as are commonly known to those skilled in the art.

### Outline

In some embodiments, the method and system can comprise software that can enable the generation of text, equations and figures with linked variable elements. At a high level, this can be performed by inserting variables into a text editor that can be search and replaced. The text editor can permit the generation of titles, sections, paragraphs, tables, lists, hyperlinks, etc. In a similar manner, variables can be inserted into mathematical equations that can be search and replaced. In some embodiments, a graphics editor can be provided to enable the insertion of variables that can act as scalable dimensions to objects in figures. This graphical editor can be based on a vector system, such as scalable vector graphics (“SVG”), or on a raster system, such as a bitmap. The variables that relate the text, equations and graphics can permit the user to generate a virtually unlimited numbers of both the problem statement and its accompanying solution.

The variables can be manipulated in various ways. In some embodiments, the variables can be prescribed to a fixed value, or a prescribed sequence can be outlined. In other embodiments, a random variable space can be defined with a minimum, a maximum range, and with an optional increment. Relationships between variables can also be defined.

In some embodiments, the method and system can comprise the ability to generate variable difficulty items. By this, it is meant that a problem set can be structured as easy, medium and hard, as an example. A student could then progress through difficulty levels as the student became more proficient at each challenge level This variable difficulty level can be set up in such a way where a single problem has variable difficulty built-in or, alternatively, easy, medium and hard problems can be combined to form a variable difficulty problem set.

In some embodiments, units to variables in the problems can also be defined or randomized. For example, metric or imperial units can be applied throughout a whole problem. Alternatively, a combination of units can be applied within a given problem.

In some embodiments, problems can be generated and stored in a database to be later retrieved, previewed, edited and combined to form things as, but are not limited to, assignments, quizzes, labs, seminars, exams, study guides and textbooks. The formatting of the material can be configured to suit the desired output document style. The material can exported to another document database base, or can be directly output in a print or digital format. In some embodiments, the digital format can be made available across a variety of platforms, viewers and browsers.

### Text Editor

In some embodiments, the text contained within a problem definition or its solution can be generated, edited or imported within a text editor. This text editor can be similar to other word processors that the user might be familiar with in that it can perform operations like: typeface selection, coloring and sizing, bold, italics, underline, cross-through, horizontal and vertical alignment, bullet and numbered lists, indentation, titles, headings, sections, sub-sections and the addition of hyperlinks. It can also comprise spelling and grammatical correction and additional word processing features, suited to a specialized audience if desired.

### Variable Editor

In some embodiments, the common link between the text, equations and graphics can be the variables. These variables can be simply parameters that can be changed when making up a new problem set. A problem set generated with the variable parameters can be called a templated item or templatable item.

In some embodiments, the variables can simply be numbers. These numbers can set to fixed value. Alternatively, they can be described by a function, that is, the number can be determined by performing calculations with a mathematical equation. In some embodiments, these numbers can be determined randomly. For example, a user might specify that the number has fall between some minimum value and some maximum value. The user could then further specify that the number be an integer (round numbers), or a floating point number (those number with decimals and possibly exponents). Perhaps, it is desired that the number be only positive or negative. Alternatively, if the number has been specified to fit within a specific range, it might further specified that it falls on certain increments. For example, if a minimum was set to 4.0 and the maximum at 8.3, with increments of 0.1, then returned values of 5.7 and 7.1 would be valid, whereas a value of 6.235 would not be permitted.

In some embodiments, a variable can be randomly selected from a predetermined list of numbers or from a predetermined list of strings. Furthermore, in some embodiments, an image for a problem can be randomly selected from a list of purchased or generated images or figures. In other embodiments, variables for any given problem, or set of problems, can be related to each other in some fashion. For example, if a certain text string is randomly selected, a corresponding image can also be selected, and perhaps certain numerical variables are not only permitted as well.

In some embodiments, certain values can be selected that a parameter may not contain. For example, when defining the division of two numbers, one would not permit division by zero if a valid number was expected.

In some embodiments, the method and system can comprise a constraint editor. In the context of randomizing variables, constraints are relationships that bind variables together. For example, if a problem is presented dealing with the lengths of the sides of a right-angled triangle, their dimensions are constrained to be linked together with the Pythagoras Theorem (a²+b²=c²). In some embodiments, several constraint equations can be applied and solved by a variety of methods.

In some embodiments, the variable editor can be presented as a scrollable list or a table, but it is not limited to that format. In other embodiments, it can invoked via a menu, a hotkey or a gesture as possible examples.

When generating a problem, predefined variables can be selected from the above mentioned variable editor, or by pressing a hotkey or a predefined character.

### Equation Editor

In some embodiments, equations can be generated to be used within the problem definition and/or the solution of an item. These equations can be of static content, or they can contain variables that enable them to change with the variable given in the problem. In some embodiments, equations can be read in from an external program or file as markup language, or as a raster or vector image. In other embodiments, an equation can entered via a graphical user interface. Employing a graphical user interface can permit the user to use a pointer to select and enter various symbols like the Greek symbol, theta, or the square-root symbol, for example. As well, equations can be typed in with a mathematical markup language like LaTOX™, AsciiMath™ or MathML™, and rendered in real-time or via post-processing. Once generated, the equations can be added to the body of the text or inserted within a drawing. A database of commonly used equations can be generated to save the user time and minimize the introduction of errors when building equations.

### Image Editor

In some embodiments, an image editor can permit the user to generate images whose properties are based on variables. These properties can include dimensions of various lengths or angles of the elements that are a part of the image. These elements can include primitive shapes such as lines, polygons and circles, or more complex structures like a drawing of an apple, cow or a house. With the use of variables, the editor can also permit a user to control the number of the elements as well as the styling of the element that can include, but is not limited to, the colors, line-types, gradients, opacity and fill types of the element.

When an object has been generated in the image editor, its size can be altered by dimensions that are controlled by the previously defined variables. These dimensions can be displayed using procedures that are frequently employed in computerized technical drafting. These can include the use of pull-down leader lines and an editable text field where the dimension can be specified or a variable entered.

When generating an object with constraints and variables, it is often necessary to have certain parts of an object that are fixed and those that can move. For this purpose, a red-green user interface can be provided. When a node of an object is selected, the object can turn red in color if it is fixed to that position. On the other hand, the object can turn green if the point is free to move.

In some embodiments, the image editor can permit snapping of an object to grid (snap to grid), or of one object to another (snap to object). When the snap to object functionality is invoked, this feature can detect when an object is close to another and it can then display that object's “important lines/points”. These important lines or points can include the object's endpoints, midpoints, centroids, tangents, perpendicular lines to, etc. Once these important points have been highlighted then when the second object is within a certain distance from the important line/point, the second object can “snap” to it. This means the two objects' axis/lines/points can be bound together, so that a further transforming can be aware of this connection, unless the line/point is physically taken outside that certain distance. In some embodiments, when an image is randomly generated, dimensions between objects can be updated based on constraints, wherein the snapping feature can generate a constraint that keeps the points snapped.

In some embodiments, shapes can be defined by a series of points or line or key geometric entities. These points can be related by fixed conditions or by constraint functions or variable dimensions. The geometry of the shapes can, thus, be altered by changing the constraint equations or dimensions.

In some embodiments, a user can import an external image into the graphical editor, The image can be composed of raster or vector content. This external image can be left in its native format, or it can be converted into the internal format that the image editor employs. If the image is converted to the editor's internal format, it can be edited just like an object that was generated natively by the editor. The user can also inject markup code into the image editor. The image editor can also permit the user to import a graphical object that has previously been defined with variables. These variables can now be incorporated into the current drawing to permit rapid development of a drawing.

In some embodiments, anchor points can be defined anywhere on an object. These anchor points can be placed at some arbitrary point on an existing object and now these locations can be dimensioned like any other part of an object. This can be a particularly useful function for an object that has been imported into the image editor.

In some embodiments, the image editor can permit mathematical equations to be placed on the drawing. These equations can be of static content, or they can contain variables which enable them to change with the variable given in the problem.

In some embodiments, drawings that are generated within the image editor can contain labels. These labels can include titles, legends, dimensions, angles, equations and text that is associated with a certain point on a drawing. However, because the position of the labels can be dependent on the randomized variable nature of the templated drawing, there is a good chance that labels will be writing over one another or portions of the drawing when new images are generated. To mitigate this problem, a smart labeling feature can be incorporated. With smart labeling, the geometry of the drawing can be positioned according to the variables and constraints used to generate the objects in the drawing. Then the labels can be applied with rules and tolerances so that they do not write over labels or objects. While it can be desirable to keep the labels position as close as possible to the point they are supposed to define, it may be necessary to use arrow leaders to indicate which point on the object that the label is referring to. A point on an object can be defined where a sticky label is applied. When this type of label is applied, it can stay in that relative position to the object that it is associated with.

In some embodiments, once an object has been generated or imported to the drawing, one can generate one or multiple copies of it. These copies can be stacked, aligned, placed in a grid and varied in size. Additionally, their shape, colors, line-types and other object properties can be altered in a pro-described manner or randomly varied.

In some embodiments, a drawing can be comprised of several objects. Several objects can be selected and then aligned through their center, right-side, left-side, top, bottom, etc.

### Dimensions

In some embodiments, one key entity in the image editor can be the ability to generate dimensions that are controlled by variables. In some embodiments, this can mean that the same variables that are used in the text and the equations can also be used to control the dimensions in the drawing. In this manner, the drawings can be drawn to scale according to the current value of the variables in the problem that is to be rendered. For example, if the problem specifies that the width of the box is 5 feet and the height is 2 feet, then the drawing of the rectangular box can be scaled in that manner. If, on the other hand, both the height and the width turn out to both be 3 feet in length, then a square box can be displayed. These dimensions can include lengths in one, two or three dimensions. The dimensions can also include angles and they can include relationships between the dimensions. More details on this are described below.

### Level of Difficulty

In some embodiments, because the problems can be constructed via a programmable structure, it can be possible to easily prescribe various levels of difficulty in a given problem. For example, in a math problem, one could prescribe input data values that can only necessitate working with simple round numbers that do not require a calculator to perform. Or to make the problem more difficult, one can use floating point values that necessitate a calculation aid. In an engineering setting, on the other hand, a simple problem can only include a single static point load force while a medium difficulty problem can include 2 or more such forces, while yet a hard problem can combine both point and distributed loads, for example.

In some embodiments, a student can be given access to a problem with varying levels of difficulty. The student can start with simple problems to begin with, until the student can gain some confidence and then proceed to more difficult levels.

In some embodiments, problems of varying difficulty can be used in the assessment of students, wherein the varying level of problems can be given different weights in accordance with their difficulty. Students can then select problems based on their confidence level with the material.

### Automated Marking

The above described randomizable assignment generation technology can generate a new problem: that of how to mark assignments that are unique to each student. In some embodiment, one approach can comprise assessing randomly generated assignments using multiple-choice questions. However, in courses involving problem solving in math, sciences and engineering at a secondary and post-secondary level, the process and details of the solution procedure can be just as important to the student's learning process, as obtaining the final answer. This problem actually presents a unique opportunity to employ hand-writing and object recognition technologies whereby students can write up their assignments by entering images, equations and text via a stylus pen on cheaply available tablets. In some embodiments, once parts of the assignments are complete, they can be sent to a server to be marked and the results sent back to the student with suggestions and/or corrections. This instant feedback can provide an optimum learning experience for the student, not to mention huge cost savings in marking costs for educational institutions. In some embodiments, a teacher or professor can now assign homework after every lecture and get immediate feedback on what was understood or poorly comprehended, and address those issues at the beginning of the next class. Student engagement during the lectures can escalate to new levels as the students will see the need to follow along and to understand the daily lecture material. Contrast this to the typical cycle in a university wherein there is often a two to three week delay between the lecture material and the students receiving their marked assignments—the teachable moments have been lost.

In some embodiments, when problems are being authored, their corresponding solutions can be also generated. In the solutions, key elements can be defined and stored in the solution database. These elements must be present in the solution. These elements can include such things as text phrases, equations and geometrical entities. Even though each problem/solution pair can be randomly generated, these key elements must be present in every solution. Thus, when a student is entering the various stages of the solution using a stylus on a tablet or similar interface, the validity of each entered text phrase, equation, geometric entity can be compared with that stored in the database. Hints and assessment can be instantly carried out to provide valuable response to both the student and instructor.

In some embodiments, this manner of real-time assessment can provide the student with a natural way to input the solution, and to obtain assistance on a step-by-step basis rather than having to wait to the end and select from a list of multi-choice answers. This process can provide a much more enriched learning environment for the students and a superior feedback system for the educators.

Broadly stated, in some embodiments, a method can be provided for generating a templatable item, the method comprising the steps of: providing a problem statement, the problem statement comprising a predetermined difficulty level; and providing a corresponding solution to the problem statement, wherein each of the problem statement and the solution further comprise at least one variable that links subject matter disposed within each of the problem statement and the solution, and that further link the subject matter between the problem statement and the solution.

Broadly stated, in some embodiments, the method can further comprise the step of combining the at least one variable with at least one other variable to generate at least one paragraph, wherein the at least one paragraph further comprises one or more of text, text fragments, images and tables.

In some embodiments, broadly stated, the method can further comprise the step of combining the at least one variable with at least one other variable to generate at least one mathematical equation, wherein the at least one mathematical equation further comprising one or both of static elements and dynamically changing elements, which can alter their content depending on the value of the at least one variable disposed therein.

Broadly stated, in some embodiments, the method can further comprise the step of generating figures that comprise scaled diagrams that are dependent on the at least one variable.

Broadly stated, in some embodiments, the method can further comprise the step of generating figures that comprise plots of functions, the plots of functions further comprising the at least one variable.

Broadly stated, in some embodiments, the method can further comprise the step of varying the difficulty level of the problem statement.

Broadly stated, in some embodiments, the method can further comprise the step of generating an assignment comprising one or more of the problem statement, wherein the assignment can comprise one or more of short answer questions, problem-solving questions, graphical placement of objects and plotting of functions.

Broadly stated, in some embodiments, the method can further comprise the steps of: providing the assignment to a student to solve the one or more of the problem statement disposed therein thereby generating a completed assignment; marking the completed assignment and generating a score on how well the student scored on the completed assignment; and providing feedback to the student as to their score on the completed assignment.

Broadly stated, in some embodiments, a system can be provided for generating a templatable item, the apparatus comprising: means for providing a problem statement, the problem statement comprising a predetermined difficulty level; and means for providing a corresponding solution to the problem statement, wherein each of the problem statement and the solution further comprise at least one variable that links subject matter disposed within each of the problem statement and the solution, and that further link the subject matter between the problem statement and the solution.

Broadly stated, in some embodiments, the system can further comprise means for combining the at least one variable with at least one other variable to generate at least one paragraph, wherein the at least one paragraph further comprises one or more of text, text fragments, images and tables.

Broadly stated, in some embodiments, the system can further comprise means for combining the at least one variable with at least one other variable to generate at least one mathematical equation, wherein the at least one mathematical equation further comprising one or both of static elements and dynamically changing elements, which can alter their content depending on the value of the at least one variable disposed therein.

Broadly stated, in some embodiments, the system can further comprise means for generating figures that comprise scaled diagrams that are dependent on the at least one variable.

Broadly stated, in some embodiments, the system can further comprise means for generating figures that comprise plots of functions, the plots of functions further comprising the at least one variable.

Broadly stated, in some embodiments, the system can further comprise means for varying the difficulty level of the problem statement.

Broadly stated, in some embodiments, the system can further comprise means for generating an assignment comprising one or more of the problem statement, wherein the assignment can comprise one or more of short answer questions, problem-solving questions, graphical placement of objects and plotting of functions.

Broadly stated, in some embodiments, the system can further comprise: means for providing the assignment to a student to solve the one or more of the problem statement disposed therein thereby generating a completed assignment; means for marking the completed assignment and generating a score on how well the student scared on the completed assignment; and means for providing feedback to the student as to their score on the completed assignment.

Broadly stated, in some embodiments, the at least one variable can comprise a number that randomly or sequentially varies between a minimum value and a maximum value.

Broadly stated, in some embodiments, the at least one variable can vary in accordance with a predetermined increment.

Broadly stated, in some embodiments, the at least one variable can comprise one or more of a group consisting of one or more words, phrases and sentences; wherein one or more of the words, the phrases and the sentences are selected randomly or sequentially.

Broadly stated, in some embodiments, the at least one variable can comprise images or tables that are included in one or both of the problem statement and the solution.

Broadly stated, in some embodiments, the at least one variable can comprise one or both of a relationship and a constraint between the at least one variable and another variable.

Broadly stated, in some embodiments, the figures can further comprise one or both of at least one mathematical equation and at least one label, the at least one label further comprising content that is controlled by the at least one variable.

Broadly stated, in some embodiments, the figures can further comprise one or more constraints that enable the figures to comprise one or more of points, line segments and surfaces, wherein the one or more of points, line segments and surfaces are constrained so that they are always in contact with one another when the at least one variable is altered.

Broadly stated, in some embodiments, the figures can further comprise one or more constraints that enable the figures to comprise entities that are a fixed distance from one another.

Broadly stated, in some embodiments, the figures can further comprise one or more constraints that enable the figures to comprise line segments that are parallel, perpendicular or at some angle relative to one another.

Broadly stated, in some embodiments, a system can be provided for generating a templatable item, the system comprising: a text editor configured to generate text; a variable editor configured to generate a variable for the templatable item, the variable editor operatively coupled to the text editor; an equation editor configured for generating an equation, the equation editor operatively coupled to the text editor and to the variable editor; and an image editor configured to generate an image, the image editor operatively coupled to the text editor, to the variable editor and to the equation editor, wherein the variable comprises one or more of the text, the equation and the image.

### BRIEF DESCRIPTION OF THE DRAWINGS

FIG. 1 is a block diagram depicting one embodiment of a system for use in templated content generation and assessment.

FIG. 2 is a block diagram depicting an example of external constraints for use with the variable editor of FIG. 1.

FIG. 3 is a block diagram depicting an example of varying the radius of a circle while keeping the other constraints the same.

FIG. 4 is a block diagram depicting the node relationships between the constraints shown in FIG. 3.

FIG. 5 is a flowchart depicting one embodiment of the steps in a constraint updating procedure.

FIG. 6 is a block diagram depicting one embodiment of labeling a point.

FIG. 7 is a block diagram depicting one embodiment of a weighting scheme for positioning the labels of FIG. 6.

FIG. 8 is a block diagram depicting an example for determining the most desirable location of a label.

FIG. 9 is a block diagram depicting the determination of a label position wherein objects do not overlap one another.

FIG. 10 is a flowchart depicting one embodiment of a process for positioning labels of objects.

### DETAILED DESCRIPTION OF EMBODIMENTS

### Details of the Variable Problem Generator

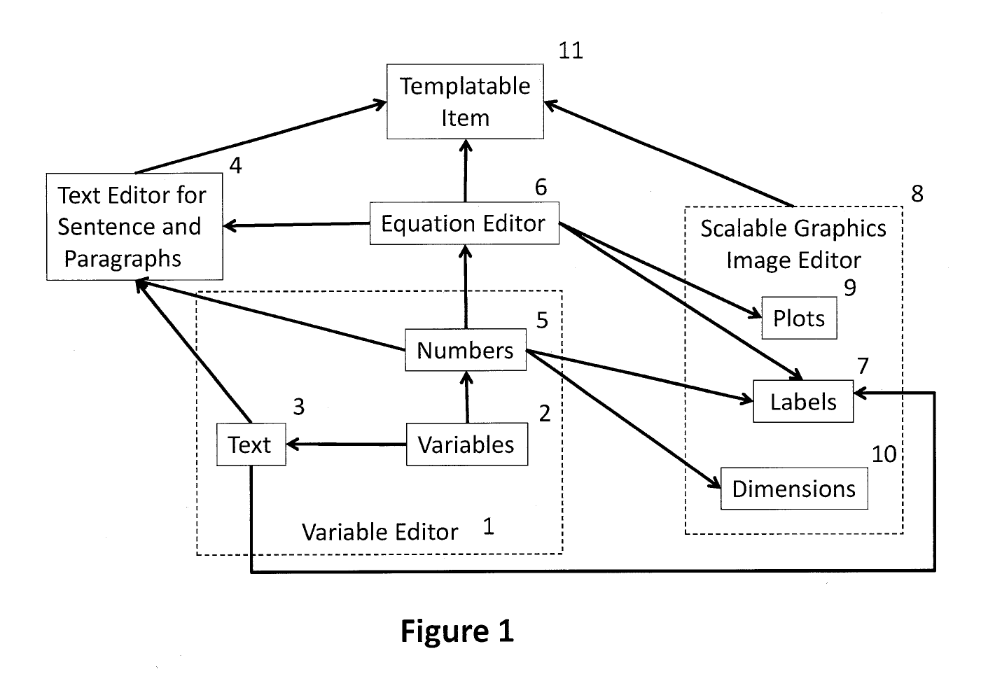

Referring to FIG. 1, one embodiment of a system for the generation of templated content and assessment is shown. In some embodiments, the generation of variables can be generated with variable editor 1. In some embodiments, variable editor 1 can generate a wide range of variables including, but not limited to, numbers, text and indexed lists. When a new instance of a templatable item is to be generated, several variables 2 can be generated with variable editor 1. If the variable is text 3, the variable could become part of sentence or paragraph 4. If, on the other hand, the variable comprises numerical variable 5, the variable could also become part of sentence or paragraph 4, or it could become an input to equation editor 6 to become part of an equation. The equations produced by equation editor 6 can be a stand-alone element, an element to be placed between paragraphs 4, or it can be an element to be a part of sentence or paragraph 4. One or more of text 3, numerical variable 5 or equations produced by equation editor 6 can also become labels 7 that can become a part of scalable graphic image generated by scalable graphics image editor 8. Equations produced by equation editor 6 can also be used to generate plots 9 as a part of graphic image 8. In addition to this, numerical variables 5 can also become driving dimensions 10 that can scale graphic image 8. In some embodiments, sentences and paragraphs 4, along with equations generated by equation editor 6 and scalable graphic images generated by scalable graphics image editor 8 can form templatable item 11.

### Details of Dimensioning

In some embodiments, one feature of the methods and systems described herein can comprise the ability to automatically rescale the images that are controlled by the variable dimensions that make up the problem. This ability can be taken care of by constraints. In some embodiments, two types of constraints can exist:

### 1. Internal Constraints:

In some embodiments, internal constraints can define the object primitives themselves. For example, a point can be defined by its coordinate positions. A line segment can be defined by the location of the line's end points, or perhaps by the location of one end point and the segment length and angle of the line. A quadrilateral can be depicted by the coordinates of the four vertices, or by the combination of some coordinates, line lengths and interior angles, as an example.

### 2. External Constraints:

In some embodiments, when more than one object is present in a figure, constraints can be defined and maintained so that the technical information can be preserved when the dimensions are altered during the randomization process. Examples of constraints between objects can include point to point, where the distance between the two points remain fixed, or point to line, where the perpendicular distance between a point and line remains constant. Many other constraints can exist including line to line and point to surface, etc.

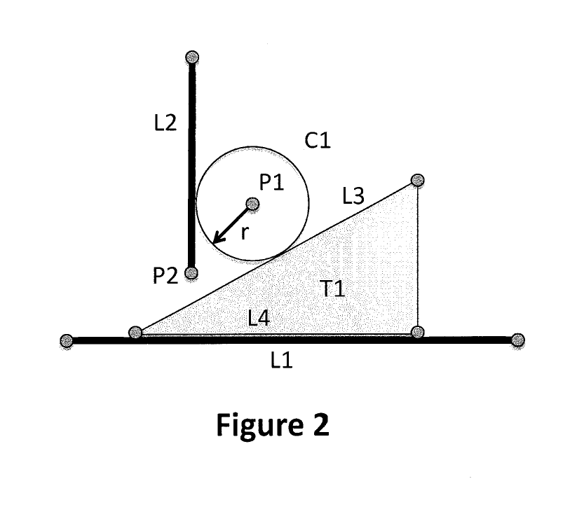

As an example of external constraints, consider FIG. 2, In some embodiments, line segment L1 can support triangle T1. Circle C1 can be supported at two locations.

The first support is on the surface of triangle T1, and the second support is given by the vertical line segment L2. Let's now illustrate how constraints can make this possible:
Line segment L1 can be constrained to have zero distance between it and the bottom edge of triangle T1, which can be line segment L4.
The center of the circle C1, which is labeled P1, must maintain a fixed distance, r, the radius of the circle from the hypotenuse of triangle T1, which is labeled L3.
The same point at the center of the circle, P1 must have a constant distance (radius, r) from vertical line L2.
Vertical line L2 must remain above the line L3 on the triangle; this means that the bottom point on the line, P2, must have some distance greater than or equal to zero above the line L3 on the triangle.
In FIG. 2 as it is drawn, line L2 is positioned perpendicular to the line L1, but virtually any angle between L2 and L1 could be prescribed.

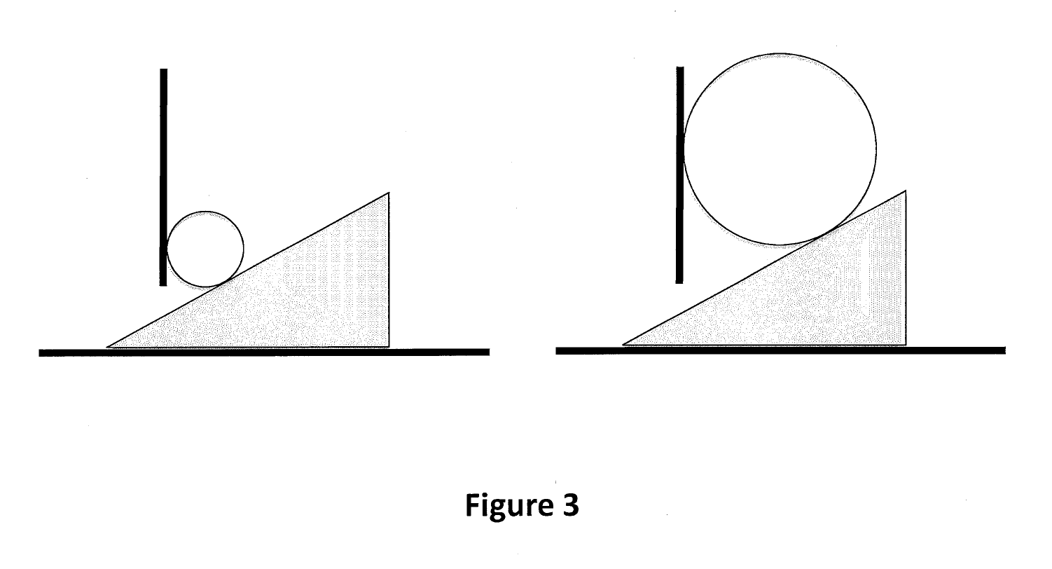

If all the variables in this drawing were kept constant, except for the radius of the circle, for example, changing the circle's radius would only move the position of the circle on the angled part of the triangle and against the vertical wall, as shown in FIG. 3.

### Node and Line Constraint Relationships

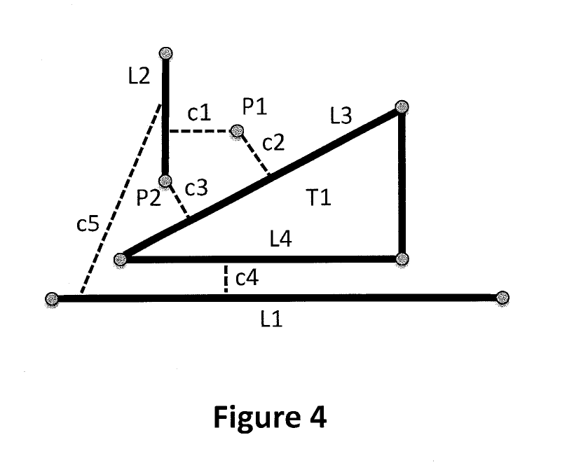

Referring to FIG. 4, FIG. 4 shows the node relationships between the constraints as shown in FIG. 3. Note the following:
The center of the circle, P1, can be constrained by c1, to be a fixed distance (the circle's radius) from the vertical line segment L2. Line segment L2 can be defined by the line's two end points, so really the constraint is set up between the three points—the center of the circle and the points on the ends of line segment L2.
Similarly, the center of circle P1 can be constrained by c2, to be a fixed distance from line segment L3 (and hence it's nodes) on the triangle; T1.
Point P2 on vertical line segment L2 can be constrained by c3, to be some fixed distance above line segment L3 on triangle T1. Additionally, point P2 can be constrained to be between the endpoints of line segment L3.
The bottom edge of triangle T1, line segment L4, can be constrained by c4, to have zero distance from the reference line segment L1. In addition to this, the endpoints of line segment L4 can be constrained to lie between the endpoints of line segment L1.
Vertical line segment L2 can be constrained by c5, which can be perpendicular to horizontal line segment L1. A further constraint to point P2 on line L2 is that it must be placed between the endpoints of line segment L2.

In some embodiments, when an update of the variables is performed, the constraints can be dealt with in two steps:
First, the internal constraints can be satisfied. As an example, if an angle and a length of a side in a triangle is changed, then the other angles and line segments that comprise the triangle must be computed.
Then, the external constraints can be considered. From any of the dimensions that have been altered from the random variable update, those nodes that are a single step away are first considered. Then, the update can move another node further away until all nodes have been updated. Should there be a conflict of the constraints, an error flag can be raised and the process can then halt.

### Logic of Constraint Updating

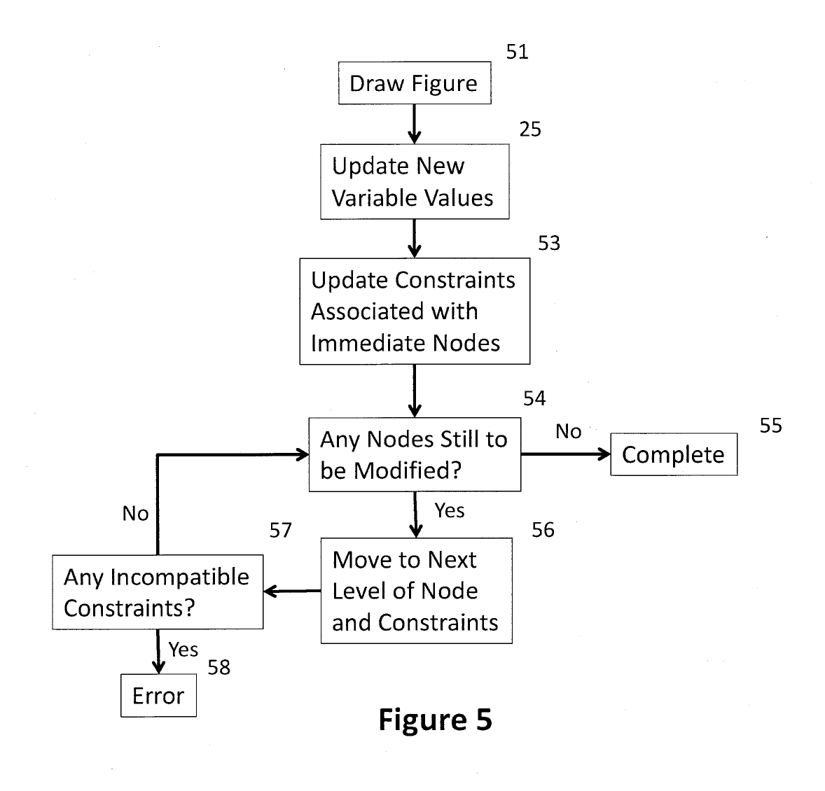

FIG. 5 illustrates one embodiment of the steps of a constraint updating procedure. The initial figure is drawn at step 51. The variables of this figure are then updated at step 52. The constraints can be applied with the immediate nodes related to the changed parameters at step 53. These could be the internal constraints of the object, or the immediately external constraints of the surrounding bodies. A check is then made to see if any nodes still have to be modified at step 54. If there are no more nodes to the changes, the drawing has been successfully updated and the process is complete at step 55. However, if there are still nodes to be updated, the process can move onto the updating of the next closest level of nodes at step 56. Constraint incompatibility can then be checked at step 57. If all is compatible, the flow returns to check for any more nodes to be modified at step 54. If an incompatibility is located, an error is returned at step 58.

### Automatic Labeling

In some embodiments when the geometry can be governed by variable parameters, labels that would have worked in one setting may collide with other labels or even the drawing itself in another iteration. As such, it can be necessary to invoke an automatic labeling system.

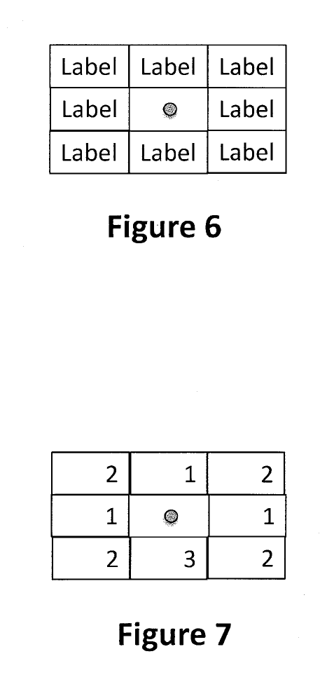

Referring to FIG. 6, consider the labeling of a point. One might decide that there are eight possible positions as illustrated. There could be more, or there could be less, depending on the document design guidelines. All positions could be equally desirable, or there could be a weighting applied so that most desirable locations can be tried first before moving on to others.

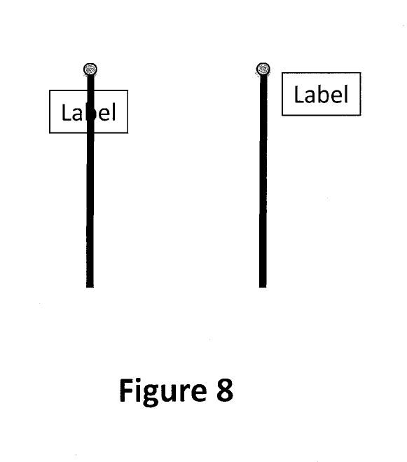

FIG. 7 shows one embodiment of a weighting scheme that could be used for label position desirability. In this illustration, the box below the point is given a weight of 3, as indicating the most desirable location, as an example. Next, the four corners are given a weight of 2 for the next level of desirability. Finally, the three other middle locations are given a weight of one. FIG. 8 illustrates this by an example. The most desired location was located just below the point, but the label location happened to go on top of another label or geometry entity, so then the label can be moved to the next most desirable location, and the check can be performed again.

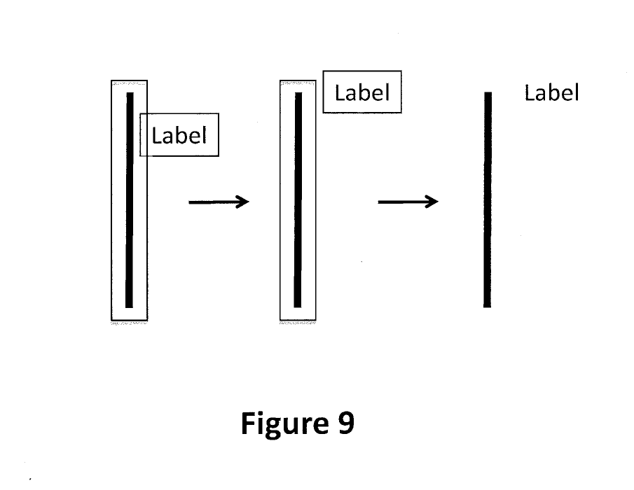

The check to see if a label is obscuring or confusing another item in the diagram can be performed by conducting interference calculations between all the objects in the figure. By interference, this can mean that the objects intersect or overlap. Every object, whether it is a label, a point, a line or a polygon, can be defined with a surrounding border that can provide some white space padding. See, for example, FIG. 9. In this figure, a line can be outlined with a box that provides a boundary around it. In the first case, however, it overlaps the bounding box of the proposed label position. The label can now get repositioned so that the label no longer overlaps the bounding box. The boxes around the line and label are for descriptive purposes only. Once the positions have been rectified, the objects can be represented without the surrounding boxes as depicted.

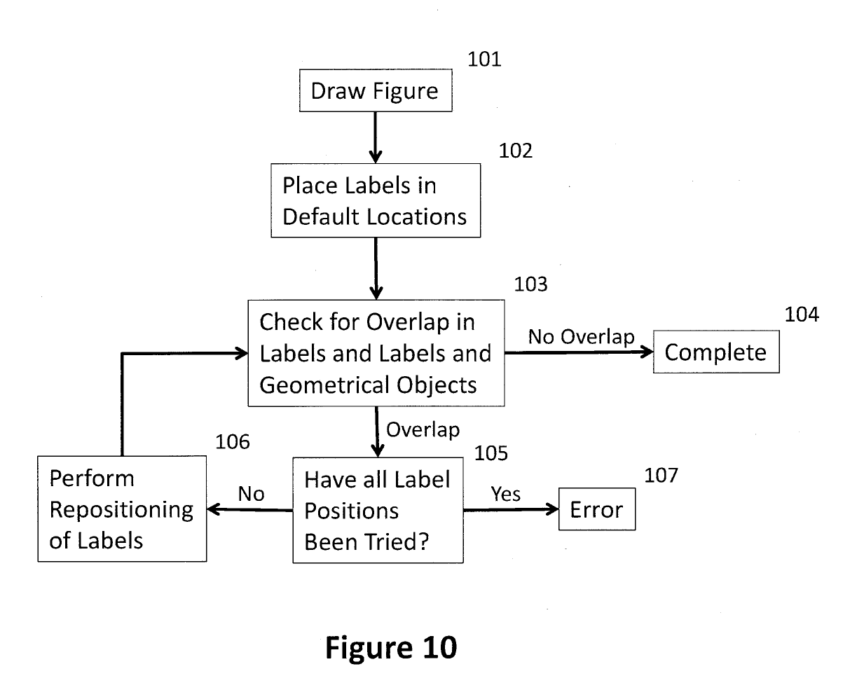

Referring to the flowchart shown in FIG. 10, one embodiment of a label repositioning process is illustrated. The geometric elements of the figure can be drawn according to current randomized and fixed variables at step 101. The default positions of the labels can then be drawn on this diagram at step 102. Tests can be now performed to determine if the labels intersect the geometric entities or with other labels at step 103. If no overlap between the entities or labels exists, the drawing is complete at step 104. However, if an overlap is detected, a check can be performed to see if all possible label positions have been tried at step 105. If there are still untried positions, the repositioning of the labels can be performed at step 105, and these positions can then be retested at step 104. This procedure can be performed until no overlap is found. If all label positions have been tried and suitable label positions cannot be generated, then that geometry can be discarded and an error message can be returned at step 107.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A method for generating a templatable item on a computing device comprising a text editor, a variable editor, an equation editor and an image editor, the method being embodied on a computer-readable medium such that, when implemented on the computing device, the method permits control of one or more of the text editor, the variable editor, the equation editor and the image editor to generate the templatable item, the computer-readable medium comprising:
a code segment that provides a problem statement, the problem statement comprising a predetermined difficulty level; and
a code segment that provides a corresponding solution to the problem statement,
wherein each of the problem statement and the solution further comprise at least one variable that links subject matter disposed within each of the problem statement and the solution, and that further link the subject matter between the problem statement and the solution.

2. The method as set forth in claim 1, wherein the at least one variable comprises a number that randomly or sequentially varies between a minimum value and a maximum value.

3. The method as set forth in claim 2, wherein the at least one variable varies in accordance with a predetermined increment.

4. The method as set forth in claim 1, wherein the at least one variable comprises one or more of a group consisting of one or more words, phrases and sentences;
wherein one or more of the words, the phrases and the sentences are selected randomly or sequentially.

5. The method as set forth in claim 1, wherein the at least one variable comprises images or tables that are included in one or both of the problem statement and the solution.

6. The method as set forth in claim 1, wherein the at least one variable comprises one or both of a relationship and a constraint between the at least one variable and another variable.

7. The method as set forth in claim 1, wherein the computer-readable medium further comprises a code segment that combines the at least one variable with at least one other variable to generate at least one paragraph, wherein the at least one paragraph further comprises one or more of text, text fragments, images and tables.

8. The method as set forth in claim 1, wherein the computer-readable medium further comprises a code segment that combines the at least one variable with at least one other variable to generate at least one mathematical equation, wherein the at least one mathematical equation further comprising one or both of static elements and dynamically changing elements, which can alter their content depending on the value of the at least one variable disposed therein.

9. The method as set forth in claim 1, wherein the computer-readable medium further comprises a code segment that generates figures that comprise scaled diagrams that are dependent on the at least one variable.

10. The method as set forth in claim 9, wherein the figures further comprise one or both of at least one mathematical equation and at least one label, the at least one label further comprising content that is controlled by the at least one variable.

11. The method as set forth in claim 9, wherein the figures further comprise one or more constraints that enable the figures to comprise one or more of points, line segments and surfaces, wherein the one or more of points, line segments and surfaces are constrained so that they are always in contact with one another when the at least one variable is altered.

12. The method as set forth in claim 9, wherein the figures further comprise one or more constraints that enable the figures to comprise entities that are a fixed distance from one another.

13. The method as set forth in claim 9, wherein the figures further comprise one or more constraints that enable the figures to comprise line segments that are parallel, perpendicular or at some angle relative to one another.

14. The method as set forth in claim 1, wherein the computer-readable medium further comprises a code segment that generates figures that comprise plots of functions, the plots of functions further comprising the at least one variable.

15. The method as set forth in claim 1, wherein the computer-readable medium further comprises a code segment that varies the difficulty level of the problem statement.

16. The method as set forth in claim 1, wherein the computer-readable medium further comprises a code segment that generates an assignment comprising one or more of the problem statement, wherein the assignment comprises one or more of short answer questions, problem-solving questions, graphical placement of objects and plotting of functions.

17. The method as set forth in claim 16, wherein the computer-readable medium further comprises:
a) a code segment that provides the assignment to a student to solve the one or more of the problem statement disposed therein thereby generating a completed assignment;
b) a code segment that marks the completed assignment and generating a score on how well the student scored on the completed assignment; and
c) a code segment that provides feedback to the student as to their score on the completed assignment.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A computer-implemented system for generating a templatable item on a computing device, the computing device comprising:
a) a text editor configured to generate text;
b) a variable editor configured to generate a variable for the templatable item, the variable editor operatively coupled to the text editor;
c) an equation editor configured for generating an equation, the equation editor operatively coupled to the text editor and to the variable editor; and
d) an image editor configured to generate an image, the image editor operatively coupled to the text editor, to the variable editor and to the equation editor, wherein the variable comprises one or more of the text, the equation and the image; and
e) a computer-readable medium comprising code segments that permit control of one or more of the text editor, the variable editor, the equation editor and the image editor to generate the templatable item.
